(19) United States
(12) Patent Application Publication
(10) Pub. No.: US 2007/0190956 A1
(43) Pub. Date: Aug. 16, 2007

(54) Wireless unit status notification system for communication network

(75) Inventors: Yu Chen, Qingdao (CN); Tandde Yong Liu, Qingdao (CN); Michael Ke Zhao, Qingdao (CN)

Correspondence Address: MCCORMICK, PAULDING & HUBER LLP, 185 ASYLUM STREET, CITY PLACE II, HARTFORD, CT, 06103, US

(73) Assignee: Lucent Technologies Inc., Murray Hill, NJ (US)

(21) Appl. No.: 11/477,986

(22) Filed: Jun. 29, 2006

(30) Foreign Application Priority Data
Feb. 10, 2006 (CN) 200610082047.2

(51) Int. Cl. H04B 1/06

(52) U.S. Cl. 455/230

(57) ABSTRACT

A status notification system is implemented on a wireless network. In a standard manner, a network user initiates a communication to a “recipient” unit at the user's “source” wireless unit. If the call is unanswered, information relating to the status of the recipient unit is obtained and transmitted for display on the source unit. The displayed status might be “busy”, “in a meeting,” or the like, as determined by the system and/or as designated by the user of the recipient unit. The status information may be obtained from the recipient unit, by referencing a database record, or by determining the operational condition of the recipient unit. In another embodiment, when the status of a wireless unit changes, or when the user of the wireless unit changes a designated status, the change in status is transmitted to each wireless unit listed on a “buddy list” for the user.

This application is entitled to the benefit of and claims foreign priority under 35 U.S.C. § 119 from Chinese Patent Application No. 200610082047.2, filed Feb. 10, 2006, the disclosure of which is hereby incorporated by reference.

### FIELD OF THE INVENTION

The present invention relates to communications and, more particularly, to services for wireless communication systems.

### BACKGROUND OF THE INVENTION

When using a wireless unit such as a mobile phone, it is sometimes the case that the calling party is unable to establish a connection with the party being called. This may happen when the “recipient” wireless unit (e.g., the wireless unit being called or otherwise contacted) is powered off or out of the network service area, or if the called party simply does not answer the call. For example, if a person is in a meeting, or is engaged in a conversation on another phone, or is driving a motor vehicle or otherwise indisposed, that person may decide to not answer an incoming call. In such situations, even if a voice-mail service is reached, the calling party will be unaware of the reason why the call was left unanswered. This may cause the calling party to retry contacting the recipient unit again and again, even if the called party is unavailable. This is especially the case if the recipient unit is in a power-off state; the calling party may repeatedly attempt to contact such a unit because the calling party is unaware and unable to determine that the unit is turned off.

If an incoming call is left unanswered, the calling party may be able to leave a message if the recipient unit being called is subscribed to a voice-mail or instant messaging service. However, the caller is still unaware of the called party's status, and will have to wait to talk to the called party in person until the called party returns the message. Moreover, the recipient unit may not be subscribed to a voice-mail or similar service.

### SUMMARY OF THE INVENTION

An embodiment of the present invention relates to a status notification method and system for wireless units on a communication network. (By “wireless unit,” it is meant mobile phones, wireless PDA's, computerized vehicle navigation systems, wireless devices with high-speed data transfer capabilities, such as those compliant with “3-G” or “4-G” standards, “WiFi”-equipped computer terminals, or the like.) Upon the occurrence of a notification condition for a first one of the wireless units, status information is transmitted to a second wireless unit. The status information relates to the operational status of the first wireless unit and/or to a designated status of the first wireless unit. The operational status is the physical status or state of the wireless unit within the network, e.g., active, power off, power on, out of service area, or the like. A designated status of the first wireless unit is a status that is set or selected by a user of the wireless unit, directly or indirectly, e.g., the user may set the criteria for the system to select one status among several possibilities. The designated status may relate to the wireless unit, but more typically relates to the status of the user of the first wireless unit, such as “in a meeting,” “off duty,” or “busy.” “Notification condition” refers to an action, circumstance, or other event (or set of events) that is designated for triggering transmission of the status information.

In another embodiment, the second wireless unit initiates a call or other communication with the first wireless unit over the network. If the call is not answered in a designated manner at the first wireless unit (here, the “notification condition” is one or more designated answer conditions such as there being no answer at the first wireless unit, or an answer from a voice-mail system), the status information is transmitted to the second wireless unit, alerting the user of the second wireless unit as to why the call was not answered, or at least providing some information to that effect.

In another embodiment, the status information is generated both as a function of wireless unit operational status and user-designated status. For example, the user may specify that if the user's wireless unit is powered down, the transmitted status information is “off duty,” “in a meeting,” “busy,” or the like.

In another embodiment, the transmission of status information is triggered by a change in the status of the first wireless unit. For example, a user may change the designated status of the first wireless unit, or it may be determined that the operational status of the wireless unit has changed, e.g., from “active” to “out of service area” or “powered down.” Upon determining that a change has occurred, status information is sent to a second wireless unit. The status information may be automatically sent to each of a number of wireless units listed in a database record (e.g., a “buddy list”) associated with the first wireless unit, informing the users of those wireless units about the change in status.

In another embodiment, status information is received from a first wireless unit and then transmitted to each of a number of wireless units listed in a database record (e.g., a “buddy list”) associated with the first wireless unit, informing the users of those wireless units about the change in status.

### BRIEF DESCRIPTION OF THE DRAWINGS

The present invention will be better understood from reading the following description of non-limiting embodiments, with reference to the attached drawings, wherein below:

FIG. 1 is a schematic diagram of a status notification system implemented on a wireless network, according to an embodiment of the present invention;

FIG. 2 is a schematic diagram of a mobile switching center portion of the status notification system;

FIG. 3 is a schematic view of a wireless unit and menu system;

FIGS. 4A-4C and 5A-5B are flow charts showing the operation of various embodiments of the status notification system; and

FIGS. 6A and 6B are schematic diagrams showing the operation of various embodiments of the status notification system.

### DETAILED DESCRIPTION

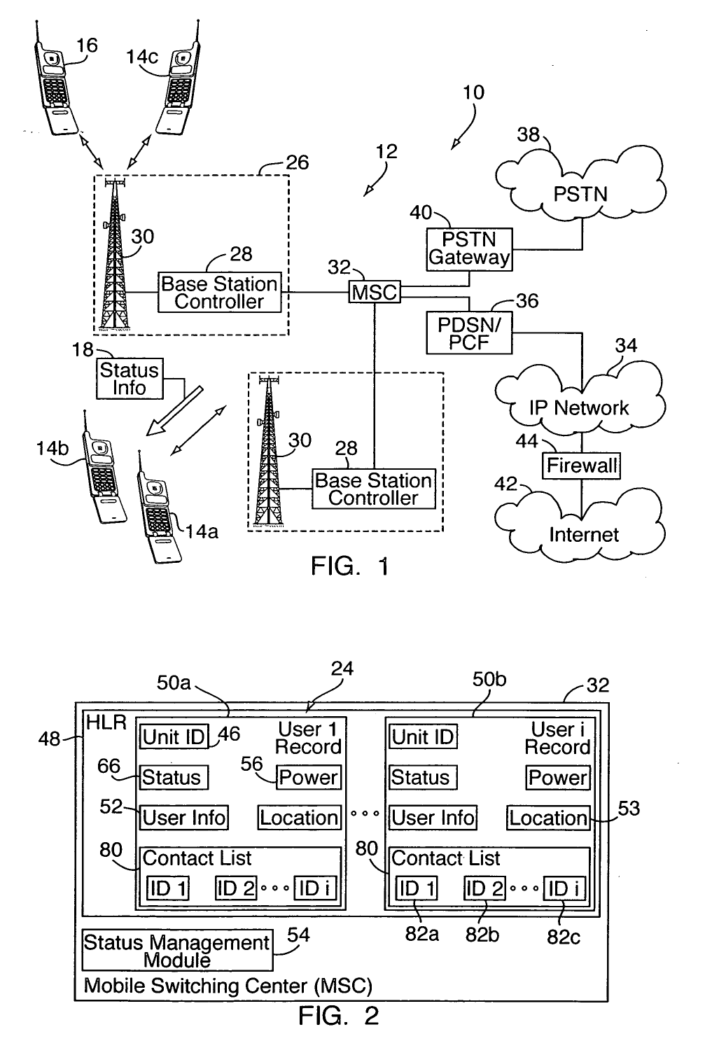

With reference to FIGS. 1-6B, a wireless unit status notification system and method 10 is implemented as a service on a wireless communication network 12. In a standard manner, a network user initiates a call or other communication at a “source” wireless unit 14a. (“Source” is an arbitrary designation for a wireless unit initiating a call or other communication.) If the user of a “recipient” wireless unit 16 does not answer the call (“recipient” is an arbitrary designation for the wireless unit being contacted or called by a source unit), the network transmits status information 18 relating to the status 20 of the recipient unit 16 for displaying on the source unit's electronic display or monitor 22. The displayed status 20 might be, for example, “busy,” “in a meeting,” or another such designation. The status information 18 may be obtained by receiving the status information 18 from the recipient unit 16, by referencing the status information in a database record 24 for the recipient unit, by determining the operational status of the recipient unit, or the like.

In another embodiment, as described in more detail below, each time the status of a wireless unit changes, or when the user of the wireless unit changes a designated status 57, the change in status is transmitted to each wireless unit 14a-14c listed on a “buddy list” or “contact list” 80 for the user.

The status notification system 10 will typically be implemented as a service on a wireless communication network 12. As shown in FIG. 1, the wireless network 12 may include one or more fixed base stations 26 each with a base station controller 28 and various transceivers and antennae 30 for wireless, radio-frequency communications with a number of distributed wireless units 14a-14c, 16. The wireless units may include mobile phones, wireless PDA's, computerized vehicle navigation systems, wireless devices with high-speed data transfer capabilities, such as those compliant with “3-G” or “4-G” standards, “WiFi”-equipped computer terminals, or the like. The base stations 26 are interconnected through one or more mobile switching centers (“MSC”) and/or radio network controllers 32. The MSC 32 performs the signaling functions necessary to establish calls and other data transfer to and from the wireless units 14a-14c, 16, and acts as the interface between the wireless/radio end of the network 12 and the rest of the network. For example, the MSC 32 may be connected to an Internet protocol (“IP”)-based network or other core packet data network 34, by way of a packet data serving node (“PDSN”) and/or packet control function (“PCF”) 36. The MSC 32 may also be connected to a public switched telephone network (“PSTN”) 38 through a PSTN gateway 40, which allows the wireless units 14a-14c, 16 to access PSTN services such as originating and receiving PSTN calls, e.g., calls to public landline phones. The core data network 34 is used for the long distance wire-line transmission of packet data, and/or to interconnect the MSC 32 with other mobile switching centers and with additional network components such as a network AAA (authentication, authorization, and accounting) module, not shown. The network 12 may also be connected to a public packet data network 42 (e.g., the Internet) through a security firewall 44 or the like.

Wireless communications between the base stations 26 and wireless units 14a-14c, 16 are carried out using standard methods depending on the type and configuration of the wireless network. For example, the radio access network 30 may be a GSM (Global System for Mobile Communications) network, a 1x-EVDO network, or the like. 1x-EVDO (“evolution data only”, or “evolution data optimized”), for example, is an implementation of the CDMA2000® “3-G” mobile telecommunications protocol/specification configured for the high-speed wireless transmission of both voice and non-voice data. 1x-EVDO networks utilize a CDMA (code division multiple access) spread-spectrum multiplexing scheme. In CDMA-based networks, transmissions from wireless units to base stations are across a single frequency bandwidth known as the reverse link, e.g., a 1.25 MHz bandwidth centered at a first designated frequency. Generally, each wireless unit is allocated the entire bandwidth all the time, with the signals from individual wireless devices being differentiated from one another using an encoding scheme. Transmissions from base stations to wireless units are across a similar frequency bandwidth (e.g., 1.25 MHz centered at a second designated frequency) known as the forward link. The forward and reverse links may each comprise a number of traffic channels and signaling or control channels, the former primarily for carrying voice data, and the latter primarily for carrying the control, synchronization, and other signals required for implementing CDMA communications. The network 12 may be geographically divided into contiguous cells, each serviced by a base station, and/or into sectors, which are portions of a cell typically serviced by different antennae/receivers supported on a single base station. For high-speed data transmission across the packet data networks 34, 42 (e.g., for facilitating web browsing, real time file transfer, or downloading large data files), the network 12 may use the Internet protocol, where data is broken into a plurality of addressed data packets. Additionally, VoIP (voice over IP) may be used for voice-data transmission. (With VoIP, analog audio signals are captured, digitized, and broken into packets like non-voice data.) Both voice and non-voice data packets are transmitted and routed over the wireless network, where they are received and reassembled by the wireless units to which the data packets are addressed.

The network 12 is shown in FIG. 1 in a simplified form for explanatory purposes. Thus, the network 12 may include additional elements not shown in the drawings, depending on the particular type of network and the manner in which the network is implemented and configured.

To initiate a call or other communication to a recipient wireless unit 16, a calling party enters the communication identifier 46 of the recipient unit 16 into his or her wireless unit 14a. The identifier 46 will typically be an alphanumeric string, address, code, or the like used to contact and/or identify a wireless unit in the network, such as a telephone number. The mobile switching center (MSC) 32 establishes the signaling pathways necessary to alert the recipient unit 16 of the incoming call. This may involve accessing a home location register (“HLR”) 48 or other database in place on the MSC 32 or elsewhere in the network 12. The HLR 48 is the main database of permanent subscriber information for the wireless network. The HLR 48 includes a database record 50a, 50b for each wireless unit. Each record includes the wireless unit's identifier (“ID”) 46 as well as pertinent user/subscriber information 52 such as address, account status, and preferences. Each HLR record 50a, 50b may also contain a field 53 for storing the current location of the wireless unit, for management of call routing as users move around the network coverage area.

Depending on how the recipient unit 16 is configured, an initiated call may cause a ring tone to sound on the recipient unit, the unit to vibrate, or the like. The user of the recipient unit 16 may then answer the call in a standard manner, e.g., by pressing a designated “call answer” button 55. In such a case, a communication link is established and maintained between the two units by the MSC/network until the call is terminated. If an initiated call is left unanswered at the recipient unit, or if the call is routed to a voice-mail system, the status notification system 10 may obtain status information 18 for the recipient unit 16 and transmit the status information to the source unit 14a. For this purpose, the status notification system 10 may include a status management module 54 in place on the MSC 32 or elsewhere in the network, depending on the network's configuration. The status management module 54 may be a script, another type of software program or suite of software programs, or a hardware/software module running on the MSC and configured to interact with the MSC 32 and/or HLR 48.

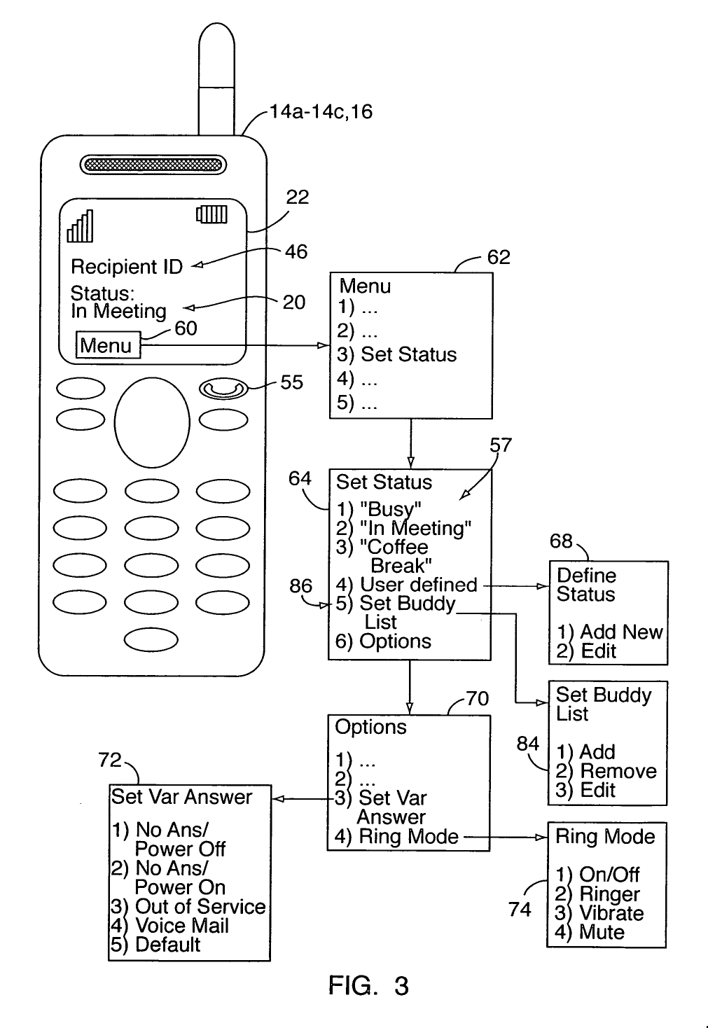

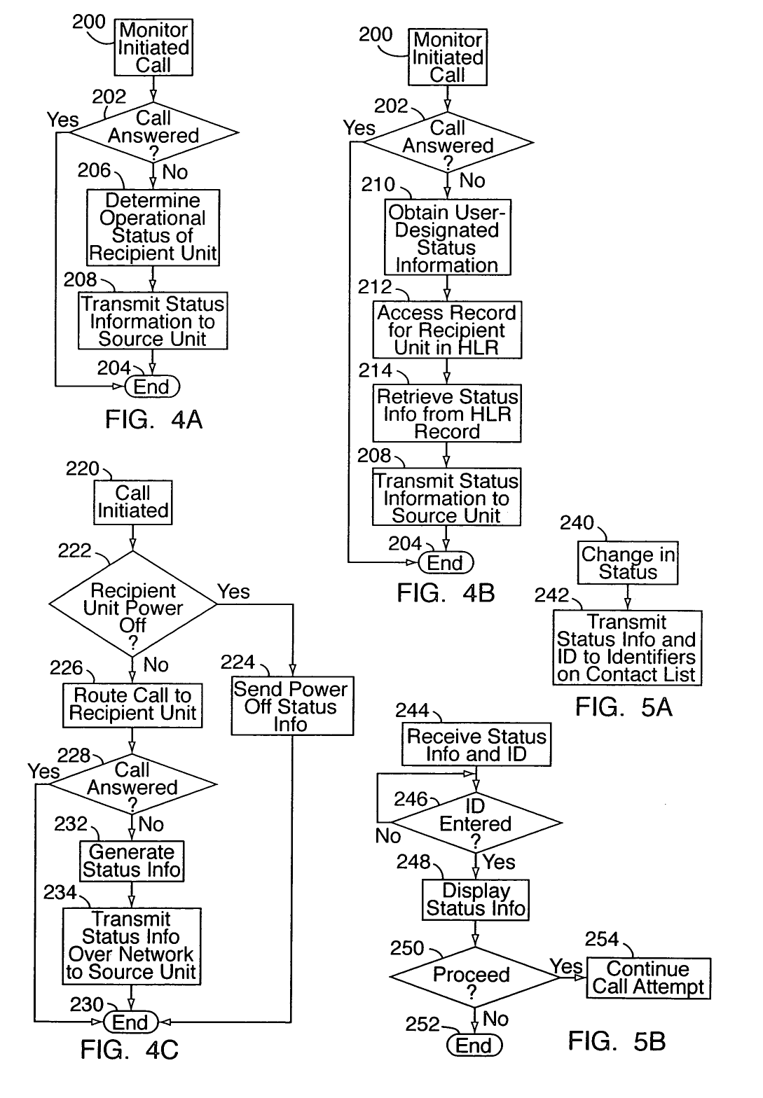

The manner and timing in which the status information is obtained and transmitted to a source wireless unit may vary. Typically, in a general sense, the system will be configured to transmit status information to a source wireless unit upon determining that a notification condition has occurred for a recipient wireless unit. As noted, a “notification condition” is an action, circumstance, or other event designated for triggering the transmission of the status information. For example, the system may be configured to obtain and transmit status information relating to the operational condition or status of the recipient unit when a call to the recipient unit is unanswered. With reference to FIG. 4A, the status management module 54 (or other portion of the system 10) monitors an initiated call or other communication on the network 12, at Step 200, as between a source unit 14a and a recipient unit 16. At Step 202, if there is a “hard answer” condition (meaning that the initiated communication has been answered at the recipient unit 16 by a user activating the “call answer” button 55 or the like), the process ends at Step 204. If not (e.g., if the notification condition is that the call is left unanswered or is routed to a voice-mail system), at Step 206 the system obtains status information by determining the operational condition or status of the recipient unit 16. For example, it may be determined if the recipient unit is powered on, if it is powered off, if it is out of the network service area, or the like. This may be accomplished by attempting to query the recipient unit, or by accessing relevant information in the MSC 32 and/or HLR 48. For example, the HLR 48 may include a power status field 56 in each record 50a, 50b, which indicates when the wireless unit associated with that record is powered down. At Step 208, information 18 relating to the determined operational status of the recipient unit 16 is sent to the source unit 14a that initiated the communication, for possible display on the source unit 14a as shown in FIG. 3. For example, the displayed status 20 could be “recipient power off,” “recipient out of service,” “recipient, power on—no answer,” or the like.

Alternatively, upon the occurrence of a notification condition, e.g., an initiated call being left unanswered or answered by voice mail, the system 10 obtains status information of the recipient unit 16 as designated by the user of the recipient unit 16, as at Step 210 in FIG. 4B. Thus, the recipient unit 16 may be configured, as indicated in FIG. 3, for the user to select a designated status or “status setting” 57 by way of a menu system 60. The menu system 60 may include a “set status” option in a first (or other) user-accessible menu 62 (electronically displayed on the display 22), which leads to a “set status” sub-menu 64 containing various additional options. For example, the user could select a “Busy” status setting, an “In Meeting” status setting, or a “Coffee Break” status setting. Once the user selects a particular status setting, the designated status is stored in the recipient unit 16 and/or transmitted to the HLR 48 for storage in a “status” field/sub-record 66 in the record 50a of the recipient unit 16. Thus, for example, if the user selects an “In Meeting” status setting 57 by way of the menu 64, this selection is transmitted and stored in the status field 66 for the recipient unit. If a subsequent call to the recipient unit is unanswered as determined at Step 202, the system performs Step 210 of obtaining the user-designated status information. For doing so, the system 10 accesses the HLR record 50a for the recipient unit 16, as at Step 212, e.g., by cross-referencing the identifier entered into the source unit 14a to the unit identifier fields 46 in the records 50a, 50b in the HLR 48. Once the record is accessed, at Step 214 the system 10 retrieves the information from the status field 66 and transmits the information to the source unit 14a (Step 208) for displaying the recipient unit's status.

The wireless units 14a-14c, 16 may be further configured as shown in FIG. 3 to allow users to modify the available status settings 57. For example, the menu system 60 could include a sub-menu 68 for a user to add a new status setting, to modify an existing status setting, or the like. Thus, if the user did not want to use a particular status setting, that setting could be removed. Additionally, new status settings individually tailored to the user's needs could be added.

The wireless units 14a-14c, 16 may be further configured for different status settings 57 to be displayed in different situations, by way of an “options” sub-menu 70 having a “set variable answer” sub-menu 72. The sub-menu 72 would contain a list of options each corresponding to a typical wireless unit operational status such as “no answer—power off,” “no answer—power on,” “out of service,” and “voice mail.” The user would choose a designated status (status setting) 57 for each of these entries, if desired. For example:

| OPERATIONAL STATUS | STATUS SETTING |
|---|---|
| No answer - power off | “Off duty” |
| No answer - power on | “In meeting” |
| Out of service | “Traveling - unavailable” |
| Voice-mail | “In meeting” |
| Default | “In meeting” |

As indicated, the list could also include a “default” entry for a status setting that would be transmitted to source units if the system 10 was unable to determine the operational status of the wireless unit, or if the determined operational condition was not included on the list. The list would be stored on the wireless unit and transmitted to the HLR 48 for storage in the status sub-record 66 of the wireless unit's HLR record 50a. Upon an initiated call resulting in anything other than a hard answer condition (for example), the system 10 would determine the operational status or condition of the recipient unit, access the HLR record 50a and status sub-record 66 for the recipient unit, cross-reference the determined operational condition to the list in the sub-record, and transmit the corresponding status setting on the list to the source unit as the status information 18.

As should be appreciated, it is possible for the wireless units 14a-14c, 16 to be further configured in a number of different ways for establishing and changing user-designated status. For example, the designated status could be based on the particular ringer mode set on the wireless unit, possibly including a “power down” condition. Thus, for example, the user of a wireless unit could select a status setting for each ringer mode of the wireless unit, through a sub-menu 74, such as the following (which would be stored on the wireless unit in memory):

| RINGER MODE | STATUS SETTING |
|---|---|
| Ringer 1 | “In meeting” |
| Ringer 2 | “In meeting” |
| Vibrate | “In meeting” |
| Mute | “Busy” |
| Power off | “Off duty” |

Each time the user changed the ringer mode on the wireless unit (e.g., through a menu selection for that function), the wireless unit would send the status setting 57 corresponding to that ringer mode to the HLR 48 for storage in the status field or sub-record 66 of the wireless unit. Further, subsequent to the user of the wireless device pressing a “power off” button on the wireless unit, but prior to actually powering down, the wireless unit could send the status setting for the “power off” field to the HLR 48 for storage in the status field 66 and/or power status field 56.

The system 10 may be configured for the status information 18 to be obtained directly from the recipient wireless unit 16, e.g., the status information is sent from a recipient unit 16 to the MSC 32 for transmitting to a source wireless unit 14a. For example, if a call initiated by the source unit 14a does not result in a hard answer condition (or upon the occurrence of some other notification condition), the recipient unit 16 sends status information to the source unit 14a. The status information could reflect a user-designated status, or it could be based on the unit's operational condition, or both. Additionally, in such a case the system 10 would typically further be configured to send default or user-designated status information to the source unit in the event the recipient unit was powered down. An example of such a process is shown in FIG. 4C. At Step 220, a call or other communication is initiated at a source unit 14a, in an attempt to contact a recipient unit 16. At Step 222, the MSC 32 and/or system 10 determines if the recipient unit 16 is powered off. If so, at Step 224 the system 10 obtains and sends to the source unit 14a status information 18 relating to the status of the recipient unit 16. For example, the status field 66 for the recipient unit may be accessed, or the system may transmit default status information for a power-down condition such as “recipient unit power off.” If the recipient unit 16 is in a power-up condition, at Step 226 the MSC attempts to route the call through to the recipient unit in a standard manner. At Step 228, it is determined if the call has been answered, e.g., a hard answer condition. If the call is answered, the process ends at 230. If the call is not answered, the recipient unit 16 generates status information at Step 232, and transmits it over the network 12 to the source unit 14a at Step 234. Generating the status information may involve accessing a user-designated status (status selection) 57 in memory, and/or determining the operational condition of the unit. The determination of whether the call has been answered at Step 228 may be carried out at the status management module 54/MSC 32 or at the recipient unit 16, depending on how the functionality of the system 10 is distributed. If the system 10 is configured so that the status management module 54 makes the determination at Step 228, the status management module 54 may send a command to the recipient unit 16 requesting that the recipient unit transmit information relating to its status, in cases where a call is not answered.

The system 10 may also include an optional “contact list” or “buddy list” feature, in operation as a standalone feature or in conjunction with additional status notification functionality such as that described above. The contact list 80 is a sub-record, list, table, or other data entry or entries located in a wireless unit HLR record 50a, 50b. The contact list 80 contains one or more wireless unit identifiers 82a-82c. The identifiers 82a-82c are entered by a wireless unit user, e.g., the user of the wireless unit for the particular HLR record 50a. Typically, the identifiers 82a-82c are for wireless units that the user contacts regularly, e.g., those belonging to family members, friends/buddies, acquaintances, co-workers, business associates, and the like. The identifiers may be entered into a wireless unit 14a-14c, 16 by way of a “set buddy list” option 86 on the sub-menu 64, which in turn leads to a “set buddy list” sub-menu 84 allowing for identifiers 82a-82c to be added, removed, edited, etc. When the identifiers are entered or modified, the updated list is sent to the MSC 32 for storage in the wireless unit's HLR record 50a. The contact list 80 may also be stored on the wireless unit, allowing for easy editing and modification of the identifiers in the contact list. The contact list, especially if stored on the wireless unit, may allow for other information to be included on the list in addition to the identifiers. For example, it will typically be the case that the names of the user's contacts are listed along with their corresponding wireless unit identifiers.

The contact list feature may function in several ways. For example, each time the status of a wireless unit 16 changes, status information to that effect (along with the identifier of the wireless unit 16) may be transmitted from the system 10 to each of the wireless units 14a-14c respectively associated with the identifiers 82a-82c on the contact list 80 for the wireless unit 16. (Here, the notification condition for triggering transmission of the status information would be a change in status.) The status information is displayed, informing the users of the wireless units 14a-14c about the status of the wireless unit 16. Alternatively, the status information may only be displayed if a user of one of the units 14a-14c enters the identifier of the wireless unit 16 in an attempt to contact the unit 16. For example, if the identifier of the wireless unit 16 is entered in a unit 14a, the unit 14a could display the status information (e.g., “user in meeting”), and then provide an option of whether or not to proceed. Changes in status may be determined from the status field 66, from a periodic network determination of status and/or operational condition, or from transmissions received from the wireless unit 16. The status information may be sent to the wireless units 14a-14c on the list 80 only when so instructed by the user of the wireless unit 16. Also, the contact list may be maintained solely on the wireless unit 16. In another embodiment, the status information is obtained as described above, but is only transmitted to a source unit 14a-14c if the identifier of the source unit is included on the recipient unit's contact list 80.

FIGS. 5A and 5B show one example of the contact list feature in operation. Initially, at Step 240 the system 10 determines or becomes aware that the status of a wireless unit 16 has changed, e.g., by referencing or monitoring the status field 66 of the wireless unit 16. (Typically, the system will monitor the status fields of all the active wireless units on the network, or at least those subscribed to the contact list feature.) At Step 242, the system accesses the HLR record 50a for the wireless unit 16, and transmits the status information 18 in the status field 66 of the record 50a to a wireless unit 14a listed in the contact list 80. (The information is also transmitted to any other units 14b, 14c in the contact list.) The system also transmits the identifier 46 of the wireless unit 16. At Step 244, the wireless unit 14a receives and stores in memory the status information 18 and identifier 46. At Step 246, the wireless unit 14a monitors whether a user has entered the identifier 46. For example, the wireless unit 14a may compare each identifier entered into the unit to a stored list of all the identifiers received from the status notification system 10. When the identifier 46 is entered, e.g., for initiating a call or other communication with the wireless unit 16, the wireless unit 14a displays the received/stored status information, as at Step 248. At Step 250, after displaying the status information, the wireless unit 14a gives the user an option of whether to proceed. If the user decides not to proceed in light of the displayed status information, the process ends at Step 252. If the user decides to proceed despite the displayed status information, the wireless unit continues with the standard call initiation process, as at Step 254.

As noted above, status information may be sent subsequent to the user of a source unit 14a-14c initiating a call or other communication with a recipient unit 16. However, even if the call is not answered, this may leave a record or other indication on the recipient unit that the source unit had attempted to contact the recipient unit, e.g., a “missed call” notification. Accordingly, the system 10 may be configured for the user of a source terminal to first enter a status access code and then the identifier of the recipient unit. The status access code acts as a notification condition for the system 10 to send status information, but without actually initiating a communication with the recipient unit and/or without alerting the recipient unit that the source unit obtained status information of the recipient unit. Thus, the system monitors source wireless units 14a-14c for the entry of the status access code, which may be an alphanumeric string designated for this purpose, such as “*201.” The identifier of the recipient unit may be entered along with the status access code, or the system may prompt the user to enter the recipient unit identifier. If a valid identifier is entered, the system obtains and sends to the source unit the status information of the wireless unit associated with the entered identifier. The status information may be obtained in a manner as described above, e.g., from a status field 66, for determining the operational status of the recipient unit, or the like.

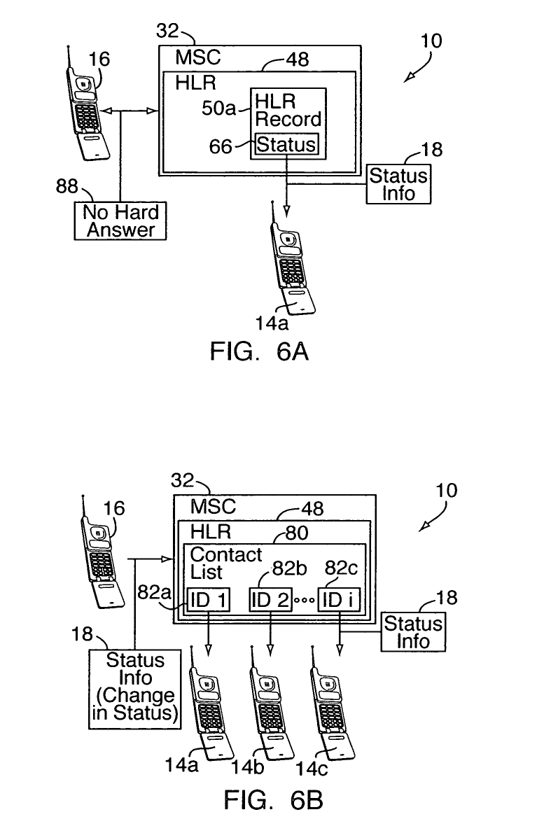

FIGS. 6A and 6B summarize the operation of various embodiments of the status notification system of the present invention in a schematic sense. In FIG. 6A, a user at a source wireless unit 14a initiates a call or other communication with a recipient wireless unit 16. The system determines if a notification condition has occurred for the recipient unit 16. For example, the notification condition might be a designated answer condition such as an unanswered call and/or a call that is answered by or routed to a voice-mail system. Upon the occurrence of a notification condition for the recipient unit 16, status information is transmitted to the source wireless unit 14a for display, to alert the user of the source wireless unit of the status of the recipient unit 16. This obviates the need for the user to repeatedly attempt to contact the recipient wireless unit. The status information may be obtained from a status field 66 in the HLR record 50a for the recipient wireless unit 16.

In the embodiment in FIG. 6B, a contact list 80 is maintained on the HLR 48 for a wireless unit 16. Status information for the wireless unit 16 is obtained and transmitted to each wireless unit 14a-14c on the contact list 80. The status information may be obtained from the HLR 48, or from the wireless unit 16. The status information may be transmitted upon receiving the status information from the wireless unit 16. Additionally, the status information may be transmitted when the status of the wireless unit 16 changes (possibly including a change in a user-designated status). Typically, the transmitted status information relates to the change in status of the wireless unit 16.

Since certain changes may be made in the above-described status notification system, without departing from the spirit and scope of the invention herein involved, it is intended that all of the subject matter of the above description or shown in the accompanying drawings shall be interpreted merely as examples illustrating the inventive concept herein and shall not be construed as limiting the invention.

We claim:

1. A method for communicating with a plurality of wireless units over a network, said method comprising the steps of:
determining if a notification condition has occurred for a first wireless unit; and, if so,
transmitting status information to at least one second wireless unit, wherein the status information relates to at least one of an operational status of the first wireless unit and a designated status of the first wireless unit.

2. The method of claim 1 wherein the notification condition comprises at least one designated answer condition for a communication initiated by the second wireless unit to the first wireless unit.

3. The method of claim 2 wherein the at least one designated answer condition excludes a hard answer condition.

4. The method of claim 3 further comprising the steps of:
determining the operational status of the first wireless unit; and
generating the status information based on the determined operational status for transmission to the at least one second wireless unit.

5. The method of claim 4 further comprising the step of:
determining the designated status as a function of the determined operational status, wherein the status information transmitted to the at least one second wireless unit relates to the determined designated status.

6. The method of claim 4 further comprising the step of:
receiving the designated status from the first wireless unit, wherein the status information is generated based on the received designated status in addition to the determined operational status.

7. The method of claim 3 wherein:
the transmitted status information relates to the designated status of the first wireless unit; and
the designated status is obtained from at least one of the first wireless unit and a status record of the first wireless unit, said status record being stored in a network-accessible database.

8. The method of claim 7 wherein the designated status is a function of a ringer mode set at the first wireless unit.

9. The method of claim 1 wherein:
the notification condition comprises a change in at least one of the operational status of the first wireless device and the designated status of the first wireless device; and
the method further comprises determining the change in the at least one of the operational status and the designated status.

10. The method of claim 9 further comprising the step of:
transmitting the status information to a plurality of second wireless units listed in a database record associated with the first wireless unit.

11. The method of claim 1 wherein the notification condition comprises receiving the status information from the first wireless unit.

12. The method of claim 11 further comprising the step of:
transmitting the status information to a plurality of second wireless units listed in a database record associated with the first wireless unit.

13. The method of claim 1 wherein:
the notification condition is receipt of a status access code; and
the method further comprises receiving an identifier of the first wireless unit and the status access code from the at least one second wireless unit.

14. A method for communicating with a plurality of wireless units over a network, said method comprising the steps of:
obtaining status information for a first wireless unit, wherein the status information relates to at least one of an operational status of the first wireless unit and a designated status of the first wireless device; and
transmitting the status information to a second wireless unit initiating communication with the first wireless unit over the network.

15. The method of claim 14 further comprising the steps of:
determining the operational status of the first wireless unit; and
generating the status information based on the determined operational status for transmission to the second wireless unit.

16. The method of claim 15 further comprising the step of:
determining the designated status as a function of the determined operational status, wherein the status information transmitted to the second wireless unit relates to the determined designated status.

17. The method of claim 14 wherein:
the transmitted status information relates to the designated status of the first wireless unit; and
the designated status is obtained from one of the first wireless unit and a status record of the first wireless unit, said status record being stored in a network-accessible database.

18. A method for communicating with a plurality of wireless units over a network, said method comprising the steps of:
obtaining status information for a first wireless unit, wherein the status information relates to a change in at least one of an operational status of the first wireless unit and a designated status of the first wireless device; and
transmitting the status information to a plurality of second wireless units listed in a database record associated with the first wireless unit.

19. The method of claim 18 further comprising the steps of:
receiving the status information from the first wireless unit, wherein the status information is transmitted to the plurality of second wireless units upon receipt thereof from the first wireless unit.

20. The method of claim 18 further comprising:
storing the status information on at least one of said plurality of second wireless units; and
displaying the status information on said at least one of said plurality of second wireless units when said at least one of said plurality of second wireless units initiates a communication with said first wireless unit.
